(19) United States
(12) Patent Application Publication
(10) Pub. No.: US 2026/0153850 A1
(43) Pub. Date: Jun. 4, 2026

(54) Monitoring Stability of Semiconductor Manufacturing Process Systems Using Digital Twins and Neural Networks

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/966,149

(22) Filed: Dec. 3, 2024

(51) Int. Cl. G05B 19/18

(52) U.S. Cl. CPC G05B 19/188; G05B 2219/45031

(57) ABSTRACT

Disclosed herein is a method for monitoring the stability of process systems in semiconductor manufacturing using digital twins and neural networks. Digital twins of both individual and group process systems are created to identify sources of subsystem parameter changes over time and assess their precise impact on process performance. This method enhances operational efficiency, uniformity, and precision in complex semiconductor manufacturing processes.

### FIELD OF THE INVENTION

This invention relates to semiconductor manufacturing, focusing on advanced process system management and optimization techniques. It addresses the critical need for monitoring the stability of process systems, particularly in complex operations requiring high precision and consistency.

### BACKGROUND

In semiconductor manufacturing, increasing complexity and the demand for atomic-layer precision necessitate sophisticated process system management. As fabrication processes advance towards finer geometries and intricate structures, ensuring consistent and stable process performance becomes critical to maintaining production efficiency and yield.

Conventional management methods often rely on static specifications and parameters that fail to address the unique and evolving characteristics of individual process systems. This approach can lead to inconsistencies, reduced yields, and increased costs due to inefficiencies and frequent manual interventions.

With subsystem performance inevitably drifting over time, it is essential for system controllers to autonomously evaluate process system stability, assess risks of failure to meet specifications, and recommend corrective actions. Current methods lack the required flexibility and intelligence to adapt dynamically while maintaining operational consistency across a group of process systems.

Thus, there is a pressing need for systems and methods that monitor and model the stability of process systems within a group, leveraging advanced digital twins and neural networks to enhance efficiency, reliability, and output quality in semiconductor manufacturing.

### SUMMARY

Disclosed herein is a method for monitoring and maintaining process system stability using digital twins and neural networks. The method ensures precision, adaptability, and consistency across diverse process environments.

Central to the invention is a group of process systems, each represented by a process system-specific digital twin. These digital twins capture the unique characteristics and operational parameters of individual systems, enabling detailed assessments, optimization, and autonomous recipe generation. The method evaluates whether a process system meets required performance specifications, ensuring effective operation within the group.

To monitor stability, subsystem-specific parameters are determined at a predetermined time by conducting measurement routines supervised by the system controller. The measurement results are used as inputs to inverse neural networks, which are trained on simulated data from digital twins, to infer subsystem-specific parameters. These parameters are evaluated using trend charts, which plot their behavior over time against predefined control limits. Parameters deviating from these limits are further analyzed against statistical distributions of subsystem parameters across the group to assess risks and identify necessary adjustments.

In cases where subsystem-specific parameters deviate from control limits, the system may generate a process recipe to evaluate the significance of the deviation. The recipe generation process utilizes the process system-specific digital twin to simulate outcomes based on the deviated parameters. If the recipe demonstrates that required process specifications can still be met, the deviation is considered low risk. However, if the recipe fails to meet specifications, the system flags the issue for corrective actions, such as troubleshooting or preventive maintenance. This approach ensures precise evaluation of parameter variations and their impact on process performance.

The development of digital twins follows a bottom-up approach, incorporating detailed models of subsystems such as RF, gas distribution, temperature control, and chamber surfaces. These models provide insights into subsystem behavior, enabling proactive stability monitoring and performance optimization.

Neural networks, trained on simulation and measured data, enhance computational efficiency and real-time adaptability. They predict and refine subsystem parameters, evaluate the impact of deviations, and optimize recipes to maintain process system performance. This system ensures uniformity across the group of process systems while enabling targeted interventions for individual systems.

### BRIEF DESCRIPTIONS OF THE DRAWINGS AND TABLES

FIG. 1A: Diagram of an exemplary process system using ALE, illustrating key components and configurations.

FIG. 1B: Functional diagram of a system controller for ALE, highlighting operational logic and control mechanisms.

FIG. 2A: Timing diagram of various steps in an ALE process across different plasma states.

FIG. 2B: Timing diagram showing gas exchange steps in an ALE process.

FIG. 2C: Schematic representation of a structure before and after ALE processing.

FIG. 3: Schematic representation of a system digital twin for an ALE process.

FIG. 4: Neural network representation of the system digital twin.

FIG. 5: Flowchart outlining the training protocol for a digital twin of the ALE system using neural networks.

FIG. 6A: Flowchart for determining resonant frequencies via trained neural network models.

FIG. 6B: Flowchart for vacuum valve setpoint determination using neural network-based predictions.

FIG. 6C: Flowchart for setting heating and cooling parameters via neural network-derived setpoints.

FIG. 7: Diagram of a group of process systems installed across a fleet of tools.

FIG. 8A: Schematic of a group-subsystem neural network, including chamber-specific subsystem neural networks.

FIG. 8B: Diagram of an inverse group-subsystem neural network, illustrating its inputs and outputs.

FIG. 9A: Flowchart for generating statistical distributions of subsystem outputs using the group-subsystem digital twin.

FIG. 9B: Flowchart for training an inverse group-subsystem neural network using data from the group-subsystem digital twin.

FIG. 10: Example of an inverse neural network generating process system-specific parameters at a predetermined time.

FIG. 11: Process for evaluating process system stability at the predetermined time.

FIG. 12: Autonomous recipe generation process.

FIG. 13: Example of a measurement engine.

Table 1: Parameters describing structures to be etched and their post-ALE processing states.

Table 2: Parameters detailing process recipes.

### DETAILED DESCRIPTIONS

In this section, we delve into the specific embodiments of the current invention to facilitate a deeper understanding. It should be noted that while implementations are described for clarity, alterations and modifications falling within the scope of the claims that follow are considered to be within the ambit of this disclosure. The detailed descriptions are intended to highlight the novel aspects of the invention, distinguishing it from conventional technology.

### Definition

### ALE (Atomic Layer Etching):

A plasma-based etching technique that removes material from a substrate layer by layer through alternating steps of surface modification and sputtering.

### Process Recipe or Recipe:

A defined sequence of steps, conditions, and durations used in semiconductor manufacturing processes, including exemplarily cycles comprising surface modification, sputtering, and optional deposition for an ALE process.

### Recipe Parameters:

Variables defining a process recipe, including cycle counts, step durations, gas flow rates, RF power settings, substrate temperatures, and optional deposition timings.

### Subsystem Control Parameters:

Operational settings for individual subsystems, such as RF resonant frequencies, vacuum valve positions, gas flow rates, and heater or chiller setpoints.

### System Digital Twin:

A virtual model of a semiconductor manufacturing process system, simulating interactions across subsystems to predict outcomes and enable real-time control.

### Reactor Digital Twin:

A subset of the system digital twin, modeling RF, gas, temperature, and plasma dynamics to predict ion and neutral fluxes, substrate surface temperatures, and overall plasma behavior.

### Chamber Plasma Digital Twin:

A component of the reactor digital twin that simulates plasma dynamics, including particle distributions, plasma sheath behavior, and plasma interactions with chamber surfaces.

### RF Digital Twin:

A model of the RF subsystem, encompassing power generators, resonators, and plasma sources, used to optimize RF power delivery and impedance matching.

### Gas Digital Twin:

A model simulating gas flow dynamics, including inflow, outflow, chamber conductance, and pressure regulation.

### Temperature Digital Twin:

A model of the thermal environment in the process chamber, including substrate temperature, heater and chiller behavior, and thermal conduction through the chuck.

### Chamber Surface Digital Twin:

A model capturing plasma-induced changes in chamber surfaces, including erosion, composition changes, and surface roughness, and their impact on process performance.

### Substrate Edge Digital Twin:

A model focusing on edge-specific behavior, accounting for plasma, gas flow, and thermal variations affecting uniformity and edge ring wear.

### Process Digital Twin:

A model simulating the evolution of substrate structures during process steps, incorporating recipe parameters, material properties, and structural transformations.

### Group-Subsystem Digital Twin:

A digital twin composed of subsystem-specific models across a group of process systems, enabling evaluation of individual subsystem behavior.

### Neural Network:

A computational model trained on simulated and measured data to replicate digital twin behavior, enabling real-time predictions and process optimization.

### Subsystem Neural Networks:

Neural networks trained for specific subsystems, such as RF, gas, temperature, and chamber surfaces, for predictive accuracy and control.

### Inverse Neural Network:

A neural network trained to infer subsystem-specific parameters based on input parameters and observed outputs.

### Group-Subsystem Neural Network:

A neural network derived from a group-subsystem digital twin, trained to predict statistical distributions and subsystem variability within a group.

### Group-Subsystem Inverse Neural Network:

An inverse neural network trained using group-subsystem digital twin data to infer parameters for subsystems in a group of process systems.

### Measurement Engine:

A component of the system controller that gathers real-time data, such as optical critical dimension (CD) measurements, to refine digital twin models and dynamically adjust process parameters.

### Plasma Sheath:

A boundary layer near chamber surfaces where ions are accelerated toward the substrate, essential for controlling surface modification and sputtering processes.

### Ion and Neutral Fluxes:

The flow of ions and neutral particles toward the substrate surface, influencing etching or deposition dynamics in plasma-based processes.

### Plasma Impedance:

A parameter representing the resistance of plasma to RF power, crucial for optimizing power delivery and impedance matching.

### Cost Function:

A mathematical function evaluating process performance by comparing predicted outputs to target specifications, guiding optimization algorithms.

### Statistical Distribution:

A representation of variability in subsystem parameters or outputs across a group of process systems, used to identify deviations and guide adjustments.

### Edge Ring:

A consumable component near the substrate edge in the process chamber, subject to wear from plasma exposure and critical for maintaining process uniformity.

### Trend Chart:

A graphical tool plotting subsystem parameters over time to monitor stability, detect deviations, and guide corrective actions in the context of statistical process control (SPC).

### Optimization Procedure:

A method leveraging digital twins or neural networks to iteratively refine parameters and improve process recipes for better performance.

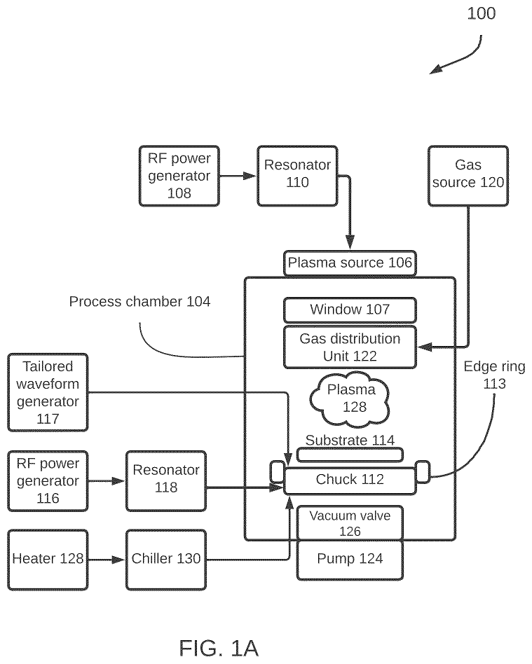

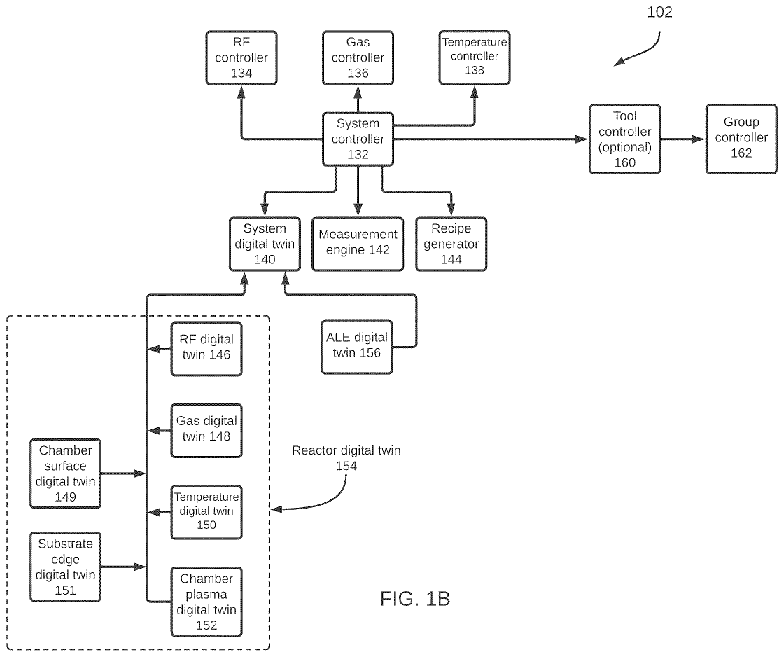

FIG. 1A illustrates an exemplary embodiment of an ALE process system, designated broadly at 100A. The ALE system is employed as an example to illustrate the present inventive concept without limiting its scope to other similar process systems, such as a reactive ion etching (RIE) system, a plasma-enhanced chemical vapor deposition (PECVD) system, an atomic layer deposition (ALD) system, a thermal etching system, or a thermal deposition system. The ALE system 100A comprises a process chamber 104, designed to maintain a vacuum suitable for plasma processing. Within this system, a plasma source 106 is configured to receive radio frequency (RF) power from an RF power generator 108 via a resonator 110. The plasma source 106 may take various forms, including but not limited to an inductively coupled plasma (ICP) source or a transformer coupled plasma (TCP) source.

The RF power generator 108 can operate at single or multiple frequencies, such as 13.56 MHz and/or 2.0 MHz. The resonator 110 plays a critical role in matching the output impedance of the RF power generator 108 to the impedance of the plasma process chamber 104, accounting for the impedance characteristics of the transmission lines. This resonator 110 is typically constructed from inductors and capacitors and may, in some configurations, include mechanically adjustable capacitors. Alternatively, in some embodiments, the resonator 110 may exclude mechanically adjustable capacitors. Impedance adjustments can be achieved by varying the operating frequencies of the RF power generator 108 and the resonator 110. During the ALE process, the plasma exhibits variable states, each associated with different impedance levels. To ensure efficient energy transfer and minimize power reflection from the process chamber 104 back to the resonator 110, fine-tuning the frequency for each plasma state may be necessary to maintain the resonator 110 in resonance.

The process chamber 104 is further equipped with a chuck 112 to support a substrate 114. The chuck 112 may be implemented as an electrostatic chuck (ESC) or a vacuum chuck, depending on the process requirements. In a preferred embodiment employing an ESC, the chuck 112 is electrically connected to an RF power generator 116 via a resonator 118. Similar to the resonator 110, the resonator 118 requires tuning to achieve a resonant state by adjusting its operating frequency. It is worth noting that the operating frequencies of the RF power generator 116 may differ from those of the RF power generator 108. For instance, the RF power generator 116 may operate at a substantially lower frequency than the RF power generator 108.

The RF power generator 116 supplies a bias voltage to the chuck 112, typically delivered through a blocking capacitor, which is standard in the field but not shown in the figure. Alternatively, in some embodiments, a tailored waveform generator 117 may be used to provide the bias voltage to the chuck 112. The application of a tailored waveform can significantly narrow the distribution of ion energies, which are generated by the ignition of plasma 128 within the process chamber 104. Depending on the implementation, the tailored waveform generator 117 may be directly connected to the chuck 112 or interfaced with the RF power generator 116.

The RF subsystem, including the RF power generators, resonators, and plasma source, is managed by an RF controller 134, as depicted in FIG. 1B. This controller communicates with and operates under the supervision of a system controller 132. In addition, the process chamber 104 integrates a gas distribution unit 122 responsible for introducing process gases from a gas source 120 into the chamber. The gas distribution unit 122 may take various forms, such as a gas injector, a showerhead, or a side injection system positioned near the chamber's inner surfaces.

The gas source 120 is typically connected to the facility's gas supply and uses a combination of valves and mass flow controllers (MFCs) to regulate the flow of gases into the chamber.

The process chamber 104 also includes a pump 124, which may be a turbomolecular pump or another suitable type, to evacuate gases and by-products from the chamber. A vacuum valve 126, generally positioned atop the pump 124, modulates the evacuation rate. Chamber pressure is monitored by a manometer (not illustrated) and controlled by adjusting the position of a movable part of the vacuum valve 126 using an actuator. The position of this movable part corresponds to the setpoint of the vacuum valve 126. The gas distribution subsystem, which encompasses the gas distribution unit 122, gas source 120, pump 124, and vacuum valve 126, is managed by a gas controller 136, as shown in FIG. 1B. The gas controller is also integrated with the system controller 132 to enable coordinated operation of the ALE process system.

In one implementation, the process chamber 104 is sealed on top by a dielectric window 107 to maintain the vacuum required for the ALE process. An opening in the window may accommodate a gas injector for delivering process gases into the chamber. This opening must be carefully sealed to preserve the vacuum integrity of the process chamber 104. If a showerhead is employed, the showerhead itself may serve as the sealing component. The inner surface conditions of the window, showerhead, and injector are known to significantly impact process performance metrics, such as defect counts and etching rates. However, a detailed mechanistic understanding of these effects remains under investigation.

The process chamber 104 further incorporates a temperature control subsystem to maintain the desired thermal conditions within the chamber. As exemplified in FIG. 1A, the temperature of the chuck 112 is regulated by a temperature controller 138, as shown in FIG. 1B, which operates a heater 128 and a chiller 130, along with a temperature sensor (not depicted). The chuck 112 may feature multiple temperature zones, each independently controlled. Additionally, temperature regulation for other chamber components, such as the gas distribution unit 122 and chamber surfaces, may also be necessary and is implemented using standard industry practices.

In state-of-the-art etching process chambers, an edge ring 113 is typically used to modulate plasma, gas flow, and temperature conditions at the edge of the substrate 114. The edge ring 113 can be fabricated from materials such as silicon, quartz, silicon carbide, or ceramics. It may include mechanisms to modulate its operating temperature or electrical potential. As a consumable component, the edge ring's thickness gradually decreases over time due to prolonged exposure to ions and radicals in the plasma 128.

An exemplary ALE process alternates between a surface modification step A and a sputtering step B in a cyclic manner. During step A, chemically active radicals generated in the plasma 128 interact with the substrate surface, modifying it chemically. The plasma is generated by the plasma source 106, powered by the RF power generator 108. Halogen-based gases, such as chlorine, are often used to produce the necessary radicals. During this step, the bias to the chuck 112 is set to zero to minimize ion impact and preserve the integrity of the ALE process. Conversely, during step B, an inert gas such as argon is introduced to generate energetic ions that physically remove the chemically modified layer through sputtering. At this stage, a bias voltage is typically applied to the chuck 112 using the RF power generator 116, resonator 118, or tailored waveform generator 117, which may be combined for optimal performance. A purge step may be employed between steps A and B to facilitate the transition of gases.

For high aspect ratio (HAR) structures, an additional deposition step C may be included in the ALE cycle sequence at a less frequent rate. This step is designed to protect the sidewalls of etched structures and prevent lateral etching caused by the angular distribution of ions.

FIG. 1B showcases the ALE process system 100A functioning as an autonomous entity, attributed to the advanced capabilities of the system controller 132. This is further detailed in a functional diagram of the autonomous control system, labeled as 100B. The system controller 132 integrates with the RF controller 134, the gas controller 136, and the temperature controller 138, ensuring synchronized operation of these subsystems. A pivotal innovation of the current invention is the incorporation of a system digital twin 140 within the system controller 132. The system digital twin 140 effectively replicates the behavior of the ALE process system 100A, positioning the system controller 132 as an intermediary between the physical system and its virtual counterpart.

Within the system digital twin 140, there are additional components: the RF digital twin 146, the gas digital twin 148, and the temperature digital twin 150, each simulating the operations of their respective subsystems.

The RF digital twin 146 emulates the RF subsystem, including the RF power generators and resonators. Its implementation may involve simulation models such as SPICE models or neural networks trained on a combination of simulated and actual measured data. In some embodiments, a hybrid approach utilizing both models and neural networks is employed for increased accuracy.

The gas digital twin 148 replicates the functions of the gas distribution subsystem, encompassing components such as the gas source 120, the gas distribution unit 122, the pump 124, the vacuum valve 126, and the manometer (not illustrated). This digital twin may utilize fluid dynamics models, analytical models, empirical models, or neural networks trained on both simulated and measured data. Hybrid implementations combining these approaches may also be used.

The temperature digital twin 150 simulates the temperature control subsystem, which includes the heater 128, the chiller 130, and temperature sensors (not illustrated). This digital twin may also account for temperature regulation in other chamber components, such as the gas distribution unit 122. Its implementation may include numerical models, analytical models, neural networks trained on simulated and real data, or a combination of these approaches.

Each subsystem within a specific chamber delivers slightly different outputs due to variations in the subsystem manufacturing process. For real-time process control, the digital twins (146, 148, and 150) must be calibrated periodically to reflect the actual performance of their respective subsystems. Calibration ensures that the digital twins capture any significant drift in subsystem outputs over time.

During plasma processes like the ALE process, the inner surfaces of the process chamber 104 are exposed to energetic ions and radicals for extended periods. Over time, the material thickness of these surfaces may degrade, causing drift in etching parameters, especially around the substrate's edge. It is critical to monitor and quantify such changes within the process chamber. Preventive maintenance procedures can also introduce significant changes in process performance due to conditioning effects on the chamber's inner surfaces.

A chamber surface digital twin 149 is designed to capture changes in chamber surfaces as a function of plasma exposure time, including the effects of preventive maintenance procedures. This digital twin focuses on selected surfaces, such as the inner surfaces of the window, the showerhead, and the injector. Due to the lack of fully established mechanistic models and rapid advancements in plasma-resistant materials, the digital twin 149 may use empirical models, look-up tables, neural networks, analytical models, numerical models, or any combination of these approaches.

A substrate edge digital twin 151 addresses the challenges of achieving consistent performance at the substrate's edge, where plasma, gas flow, and temperature behave differently compared to the central substrate areas. The edge ring 113 is used to modulate process performance at the edge, but its thickness decreases over time due to prolonged plasma exposure. The digital twin 151 may incorporate empirical models, look-up tables, neural networks, analytical models, numerical models, or a combination of these methods to account for these edge-specific effects.

The chamber plasma digital twin 152 simulates the internal plasma dynamics within the process chamber 104. It incorporates input from other digital twins (146, 148, 150, 149, and 151) to create a comprehensive model of electron, ion, and neutral particle behavior. This model may represent particle distributions in three dimensions or as a simplified two-dimensional version, either continuously over time or as discrete snapshots. It characterizes properties such as particle energy, velocity, and density.

For instance, in a scenario using an ICP plasma source, RF power from the RF power generator 108 via the resonator 110 generates an electromagnetic field that creates electrons near the ICP source. These electrons interact with the field to produce ions and neutral particles, a process well-established in the field. The digital twin 152 can simulate the formation of the plasma sheath near the substrate and the inner surfaces of the chamber, accounting for historical particle distributions influenced by real-time controls such as frequency adjustments, pressure regulation, and temperature management.

The chamber plasma digital twin 152 may employ sophisticated numerical models requiring significant computational resources. To improve efficiency, a neural network trained on numerical modeling outputs may be used. Real-world measurements, such as magnetic field distributions recorded using B-dot probes or electron density measurements from hairpin probes, can enhance the neural network's predictive accuracy. In some implementations, analytical models may supplement numerical and neural network-based approaches.

Understanding the behavior of particles within the ALE process system is crucial for modeling ion and neutral fluxes to the substrate surface. The plasma sheath's properties, pivotal for accurate flux calculations, are integral to these models. These fluxes, essential for the ALE process, may also be measured with specialized apparatus to further refine neural network training data.

The digital twins—including the RF digital twin 146, the gas digital twin 148, the temperature digital twin 150, and the chamber plasma digital twin 152—form the reactor digital twin 154. The chamber surface digital twin 149 and the substrate edge digital twin 151 enhance accuracy by capturing the effects of “drift” caused by plasma exposure on chamber components. This integrated digital twin provides critical outputs, including ion and neutral fluxes to the substrate surface, temperature distributions, and bonding distributions, enabling precise real-time process control.

The overarching system digital twin 140 extends to include the process digital twin 156, which uses ALE as an example. The process digital twin 156 integrates outputs from the reactor digital twin 154 to simulate the evolution of substrate structures during the ALE process. It inputs data on substrate characteristics such as mask layers, thickness, material properties, dimensions, and profiles of structures, as well as the properties of the target layer for etching.

Beyond this, the ALE digital twin 156 processes recipe parameters like the durations for steps A and B, the total ALE cycle count, insertion points and durations for step C, along with any pulse modulation specifics such as pulse duration and duty cycles, if applied within the ALE steps.

Other parameters, particularly those related to subsystems like RF power settings, are already encompassed by the respective digital twins (146, 148, 150). It should be noted that there are many variations in implementing an ALE process. For example, the step C is optional and may not be used for certain applications like etching a film with a thickness less than 100 nm. There are also many variations in implementing pulse schemes for the plasma source and the bias. All such variations fall into the present inventive concept.

For implementation purposes, while a Monte Carlo simulator or other numerical simulators might provide high accuracy, they often demand considerable computational resources, which can be a drawback for real-time applications. An alternative approach involves deploying a neural network within the ALE digital twin 156. Initial training with simulated data followed by subsequent refinement using empirical data ensures a robust, responsive system. In some implementations, the ALE digital twin 156 may be developed as a hybrid, employing both analytical and numerical models or combining analytical models with neural networks. The self-limiting behavior of the ALE process lends itself well to analytical modeling, efficiently capturing fundamental ALE responses. Numerical models or neural networks can be incorporated to address deviations from the ideal process, like lateral etching or depth loading effects. This synergy between models enhances the precision of predictions while maintaining computational efficiency.

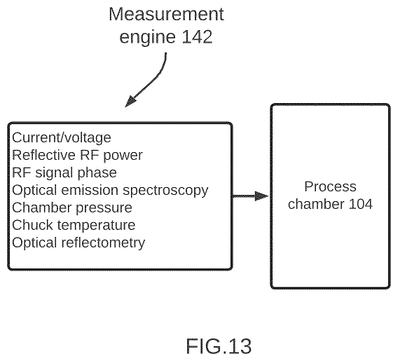

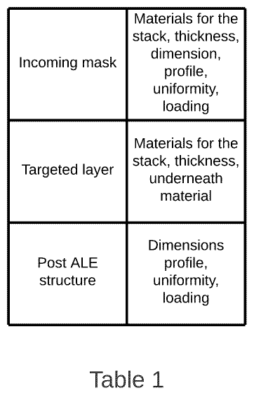

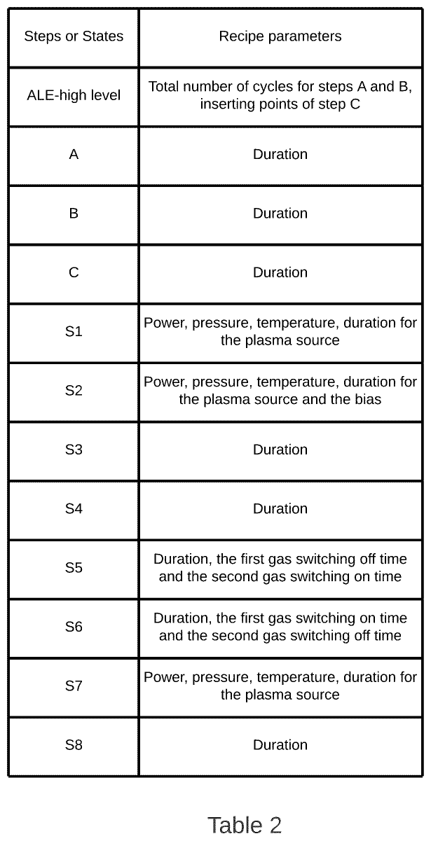

The system controller 132 is additionally equipped with a measurement engine 142 and a recipe generator 144, both of which synergistically collaborate to autonomously generate an ALE process recipe, along with the parameters for subsystem control. The measurement engine 142 includes various sensors, as exemplified in FIG. 13. These sensors include, but are not limited to, an IV probe for measuring RF current and voltage, an RF power sensor for detecting reflective RF power, phase sensors for monitoring RF current or voltage phases, optical emission spectroscopy sensors for analyzing neutral compositions in the chamber, a manometer for chamber pressure, temperature sensors for chuck temperature measurement, and sensors employing optical reflectometry techniques to monitor structure progression on the substrate.

Furthermore, subsystem control parameters can deviate from targeted ones because of variations and drifts in the subsystem components. The measurement engine 142 may capture the subsystem parameters in real-time and consequently improve the prediction accuracy of the digital twins.

The recipe generator 144 can be used to design a process recipe prior the substrate is loaded onto the chuck for processing. The recipe generator 144 can also take the outputs of the measurement engine 142 in real time and apply the system digital twin 140 to adjust recipe and subsystem control parameters for the remaining steps of the ALE process.

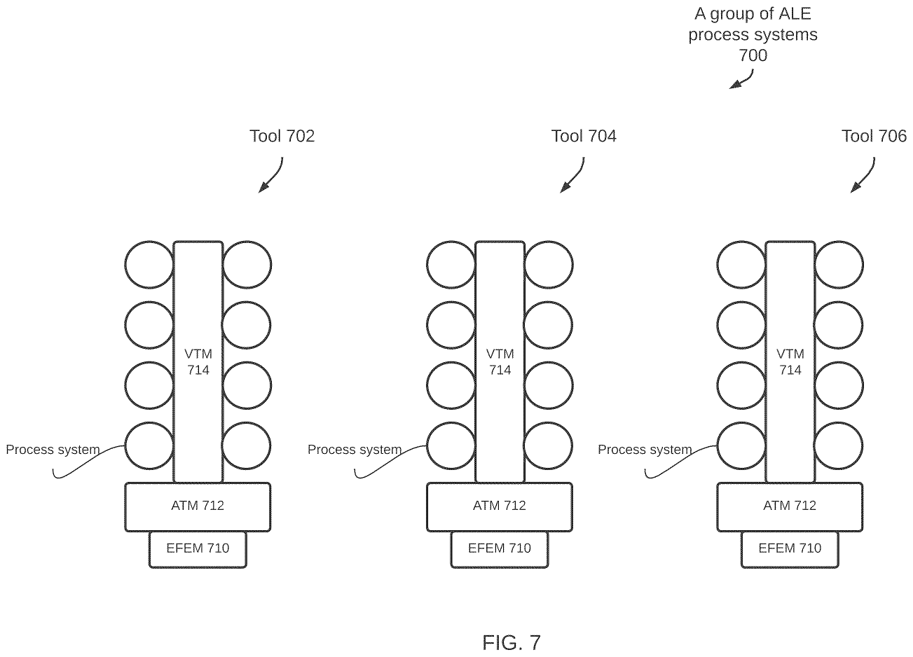

The system controller 132 is further connected to a tool controller 160 and a group controller 162. A schematic diagram of a group of process systems installed at different tools (702, 704, and 706) is depicted in FIG. 7. Three tools are illustrated as an example. There may be many tools to form a group of chambers. Each tool may include a tool level controller (160). The group of the tools may have a centralized controller (162). Each tool further includes an equipment front end module (EFEM) 710, an atmosphere transfer module 712, and a vacuum transfer module 714.

Detailed descriptions of various embodiments will be elucidated in the subsequent paragraphs of this disclosure. Across all embodiments, digital twins are utilized to enhance the system's performance. In certain embodiments, advanced optimization procedures are applied to initially formulate the recipe and the subsystem control parameters, which are then subjected to iterative optimization.

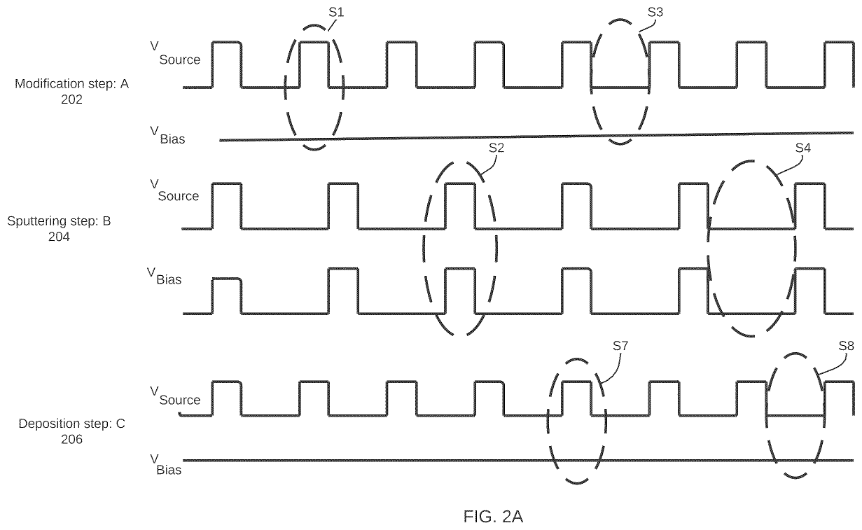

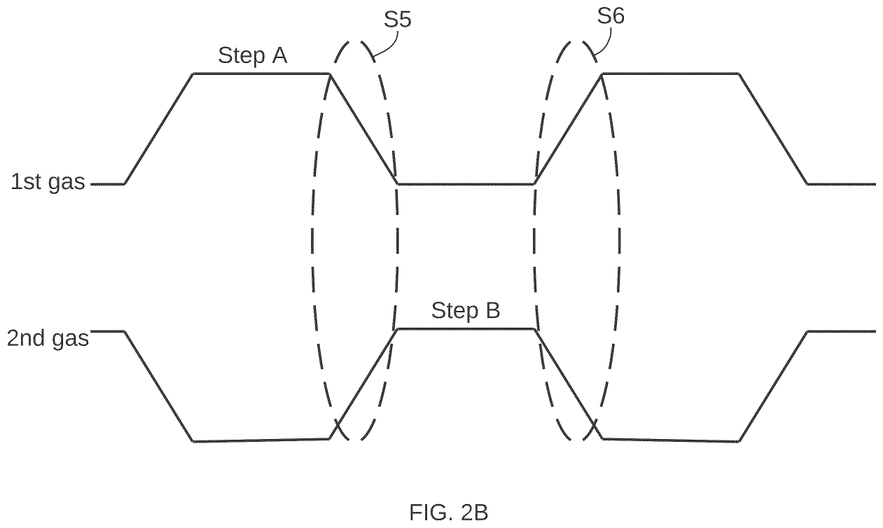

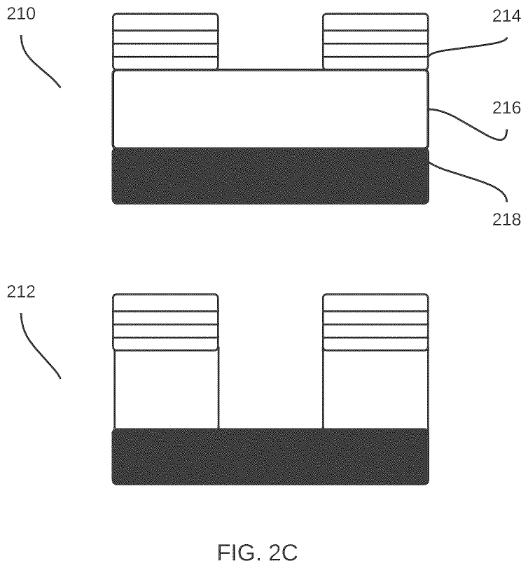

FIG. 2A depicts various states in steps A, B, and C. State S₁ represents a state in the surface modification step A 202, where the plasma source 106 receives RF power from the RF power generator 108, while the bias voltage for the chuck 112 is set to be zero. This state is crucial for enabling surface modifications without a chuck bias, thereby avoiding energetic ions impacting the substrate surface. State S₂ reflects a state in the sputtering step B 204, where the chuck is biased by either the RF power generator 116 and/or the tailored waveform generator 117. This bias voltage is essential for the sputtering process as it directs the energy and trajectory of ions toward the substrate.

State S₃ captures another state within the surface modification step 202, where both the plasma source 106 and the chuck 112 cease to receive RF power. This state remains significant as radicals generated during S₁ continue to modify the substrate surface. State S₄ illustrates a state in the sputtering step B 204, wherein both the bias and the source are turned off. This state can be significant for allowing byproducts to diffuse out of a high aspect ratio (HAR) structure.

States S₇ and S₈ pertain to the deposition step C 206. State S₇ is used to generate ions and neutrals for deposition, while state S₈ allows the generated neutrals to diffuse into desired positions within the HAR structure. These states facilitate the deposition of a layer to protect the sidewalls of structures being etched during the ALE process.

FIG. 2B showcases an exemplary ALE process utilizing the process system 100, including transitions between process gases. During state S₅, the first gas for the modification step 202 is ramped down, and the second gas for the sputtering step is ramped up. This transition is critical for switching between the two distinct steps (A and B) of the ALE process. Conversely, state S₆ represents the ramping up of the first gas for the surface modification step A 202 and the ramping down of the second gas for the sputtering step B 204, marking the preparation for a return to the modification step.

FIG. 2C illustrates an exemplary incoming structure 210 and a structure 212 post-ALE process. The incoming substrate 210 includes a mask layer 214, a targeted layer 216 to be etched by the ALE process, and a layer 218 underneath the targeted layer. As shown in Table 1, the dataset describing the incoming mask includes, but is not limited to, materials for the mask stack, thickness, mask dimensions, profile, uniformity, and loading created from previous process steps. In some implementations, the mask stack is a photoresist layer. In other implementations, the mask layer may be a hard mask, such as a carbon layer, silicon oxide layer, silicon nitride layer, or a combination thereof. These properties need to be disclosed to enable the ALE digital twin. The dataset also includes information about the targeted layer 216, such as material properties, thickness, and the characteristics of the underlying material, which may affect the profile near the bottom of the structure post-ALE.

As further detailed in Table 1, parameters describing the structure post-ALE 212 include dimensions, profile, uniformity, and loading. The profile may be characterized by parameters such as top and bottom dimensions, bowing, and the position of bowing. Loading includes the isolation-to-dense pattern dimension and depth differences post-ALE process.

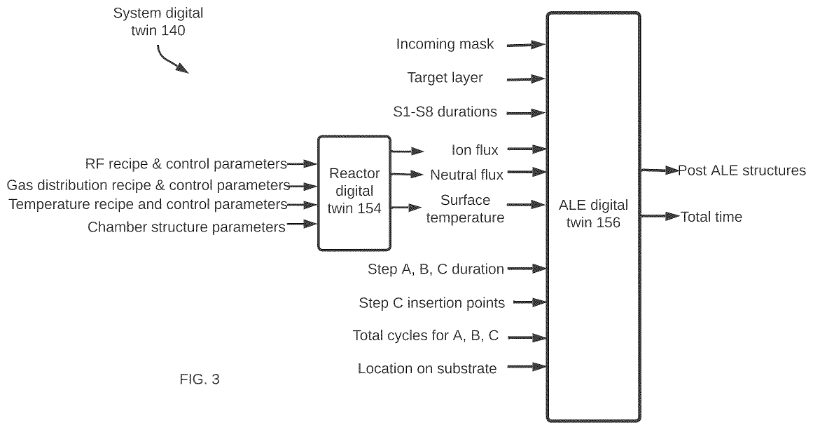

FIG. 3 provides a schematic overview of the system digital twin 140 for the ALE system 100, offering a comprehensive digital representation of the physical ALE process. The system digital twin 140 includes the reactor digital twin 154, which assimilates various subsystem parameters and chamber structure parameters into its computational framework. These inputs are essential for accurately simulating the physical interactions and phenomena occurring within the ALE reactor. Recipe parameters are also incorporated to predict plasma performance in the process chamber 104.

The reactor digital twin 154 outputs detailed predictions of ion and neutral fluxes, as well as substrate surface temperature. These outputs serve as key inputs to the ALE process digital twin 156, bridging subsystem parameters with process outcomes. The ALE process digital twin 156 further incorporates parameters specific to the ALE process, including mask parameters for the incoming substrate and parameters for specific layers targeted for the ALE process, as shown in Table 1. Additionally, it integrates detailed ALE recipe parameters, such as the duration of specific states (S₁ to S₈), durations of steps A through C, insertion points for step C, and the total number of cycles for each step, as shown in Table 2. Spatial data pinpointing the locations of structures to be processed on the substrate is also included. These inputs enable the ALE process digital twin 156 to project outputs, including the characteristics of post-ALE process structures (as shown in Table 1) and the overall processing time for the ALE cycle.

For implementation, the ALE process digital twin 156 may utilize a model-based approach, a neural network, or a hybrid of both, depending on the complexity of the ALE process, the need for real-time feedback, and prediction accuracy requirements. Neural networks, if employed, can leverage the foundation provided by the system digital twin, using computational techniques such as Monte Carlo simulations or numerical models. The simulation data generated by the system digital twin 140 can be used to train the neural network, with additional real-world measurements validating and refining the simulated data to enhance robustness and reliability.

This digital twin framework provides a virtual yet precise reflection of the ALE process, enabling improved understanding, control, and optimization of the complex interactions and parameters that govern ALE system performance.

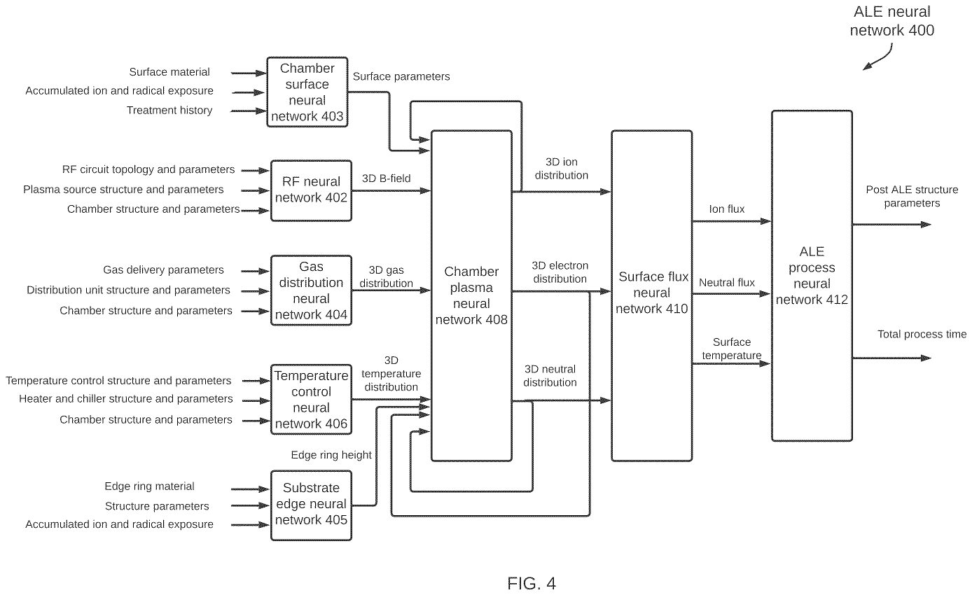

FIG. 4 illustrates an exemplary process system represented as a neural network 400, where the subsystems are captured using various neural networks. For example, the RF digital twin 146 forms the basis for training the RF neural network 402. Taking the plasma source 106 attached to the RF power generator 108 and resonator 110 as an example, a SPICE model can simulate the generator, resonator, and their transmission lines. This SPICE model provides initial AC current and voltage data for the plasma source coils 106, assuming an initial plasma impedance. A numerical simulator then applies Maxwell's equations to predict the electromagnetic field distribution within the process chamber 104.

The simulation data generated by the RF digital twin 146 is used as a training set for the RF neural network 402. Inputs to the neural network include RF circuit topology and parameters such as the values of inductors, capacitors, resistors, and transistors in the generator and resonator, along with effects from transmission lines. Additional parameters, such as the size, position, resistivity, and coil turn count of the plasma source, are incorporated into the training process. The RF neural network 402 also considers chamber structure parameters, including dimensions, positions of the chuck and window, and material properties. Some parameters, measurable through sensors, are assigned greater weight during training. For instance, sensors may monitor current and voltage changes in the coils or measure reflected power at the resonator's output node 110. A B-dot sensor with multiple small coils could be positioned in the chamber to map the magnetic field distribution, ensuring that the RF neural network 402 aligns closely with observed physical behaviors.

Modeling the bias portion of the RF subsystem using a neural network focuses on the electric field initially generated in response to applied RF power. Unlike the magnetic field related to plasma generation, the bias pertains to the electric field's effects on the substrate surface.

Transitioning to the gas dynamics within the system, we examine the gas distribution neural network 404, which is derived from the gas digital twin 148. Numerical fluid dynamics forms the foundation for determining the gas distribution within the process chamber 104. This interplay involves the gas inflow from the gas distribution unit 122, the outflow managed by the pump 124 and the vacuum valve 126 and is influenced by the chamber's conductance and volumetric parameters. While numerical simulations provide accuracy, their computational intensity and time constraints necessitate a more efficient approach for real-time applications, leading to the development of the gas distribution neural network 404.

The gas distribution neural network 404 is trained on simulation data incorporating parameters such as the types and flow rates of gases, the design of the gas distribution unit 122, the pump's capacity 124, the position of the movable part of the vacuum valve 126, and the chamber dimensions and conductance. The position of the movable part is controlled by the setpoint of the vacuum valve 126. The gas distribution unit 122, implemented as an injector, a showerhead, or a combination of both, significantly affects gas distribution within the process chamber 104. Key design parameters include the size, quantity, and distribution of channels in the injector and the showerhead. Gas pressure within the process chamber, monitored by a manometer, provides real-world data that enhances the training of the gas distribution neural network 404. This measured data often carries more weight than simulation data to ensure the model's accuracy under actual conditions.

The temperature control neural network 406, derived from the temperature digital twin 150, maps the thermal landscape within the chamber, particularly at the substrate surface. Training for the temperature control neural network 406 originates from numerical models simulating heat interactions and distributions. Inputs include chuck and chamber parameters that affect thermal conduction. In scenarios utilizing an electrostatic chuck (ESC), the thermal properties of the ESC and the efficiency of heat conduction, influenced by helium pressure as a medium, are critical. Setpoints for heating and cooling elements, such as the heater 128 and chiller 130, and chamber specifications, including size and construction materials, are also integral inputs. Temperature readings from sensors positioned in the chuck 112 and chamber 104 provide real-world data, which may carry greater weight in training to closely mimic the physical environment. This combination of simulated and measured data ensures the neural network's predictions are highly accurate and applicable to the ALE process system.

The inner surfaces of the chamber, such as the window, gas injector, and showerhead, are subject to degradation over time due to plasma exposure. The chamber surface neural network 403 models these “memory” effects, drawing inputs such as surface material, accumulated ion and radical exposure, and treatment histories. Outputs include surface parameters like structure, composition, roughness, and sticking coefficient, which collectively influence chamber radical and ion distributions. Training data for the chamber surface neural network 403 originates from the chamber surface digital twin 149 and can be augmented with measured data obtained from specially designed testing apparatus. This neural network mimics the digital twin with significantly improved computational efficiency.

Consumable parts in the process chamber 104, such as the edge ring, experience dimensional changes due to prolonged plasma exposure. For instance, a reduction in edge ring thickness can substantially affect process performance at the substrate's edge. The substrate edge neural network 405 mimics the substrate edge digital twin 151, achieving greater computational efficiency. Input parameters include the edge ring material, structural parameters such as initial height, and exposure history to ions and radicals in the plasma. Outputs include the remaining height of the edge ring. In some implementations, the temperature and electrical potential at the edge may also serve as inputs to predict the edge ring erosion rate or outputs for the chamber plasma digital twin or neural network.

FIG. 4 illustrates further an ALE reactor where the outputs of subsystem neural networks serve as inputs to the chamber plasma neural network 408. This network, based on the chamber plasma digital twin 152, provides a sophisticated representation of the plasma dynamics within the etching chamber. Simulating particle movements within the plasma involves either Monte Carlo methods or numerical plasma simulators to visualize the three-dimensional distributions of electrons, ions, and neutrals. The lighter electrons move faster than ions, forming a plasma sheath on chamber surfaces. This sheath accelerates ions toward the substrate, a critical aspect for sputtering but potentially disruptive during surface modification.

The chamber plasma neural network 408 integrates simulation data for rapid and efficient computation. Measured data from chamber sensors, such as optical sensors detecting light emission from neutrals and hairpin sensors gauging electron density, refine the network's predictive capabilities. Measured data is weighted more heavily than simulated data to align outputs with actual system behavior.

The chamber plasma neural network 408 employs a recurrent neural network (RNN) design, allowing it to process temporal sequences. This design enables the network to incorporate snapshots of plasma conditions into future predictions, reflecting the dynamic evolution of the plasma state. Once the network computes three-dimensional distributions, ion and neutral fluxes to the substrate surface are determined using the surface flux neural network 410. These fluxes, along with substrate surface temperature, are inputs for the ALE process neural network 412.

The ALE process neural network 412, trained on data from the ALE digital twin, provides outputs such as post-ALE structure parameters (listed in Table 1) and total process time. Together, the chamber plasma neural network 408 and surface flux neural network 410 generate valuable insights beyond fluxes, including surface temperature and chemical bonding distributions. These outputs are critical for fine-tuning the ALE process to achieve precise etching and high-quality substrate surfaces.

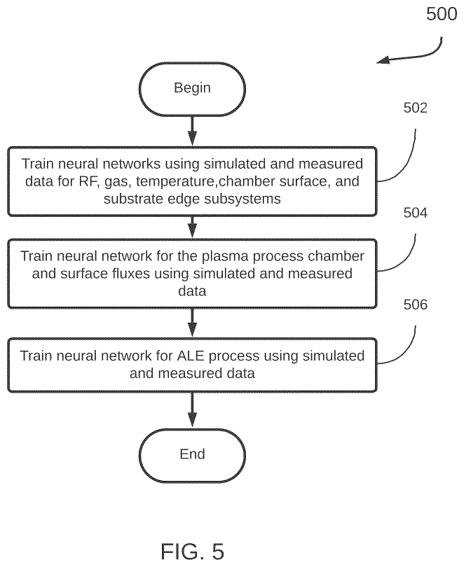

FIG. 5 presents a flowchart outlining the methodology for training the ALE neural network 400. The process 500 begins at step 502, where the subsystem neural networks (402, 404, 406, 403, and 405) are trained using simulated data. Following this, at step 504, the neural network 408/410 is trained utilizing simulated data. In step 506, the ALE process neural network 412 is trained with simulated data, including the outputs from steps 502 and 504. The training regimen for each neural network is further refined by incorporating measured data related to the subsystems, the plasma chamber, and the ALE process itself. Techniques to increase the weight of measured data include constructing a cost function with higher weights assigned to measured data or reusing measured data with artificially added low-level noise to enhance robustness.

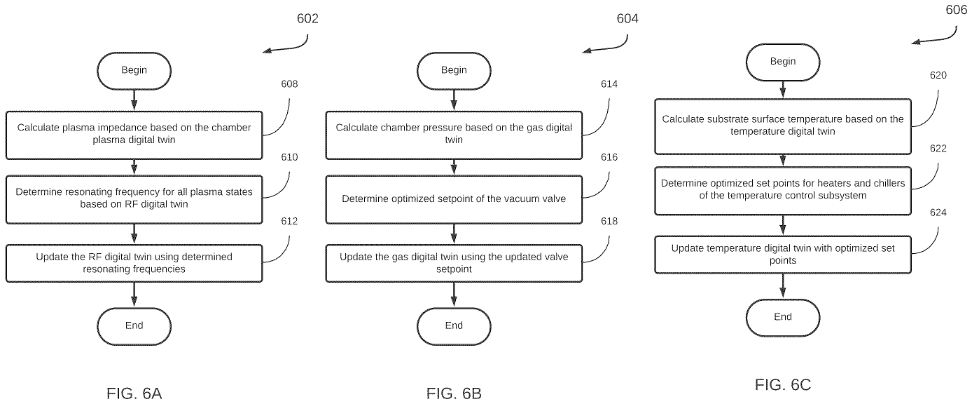

FIG. 6A depicts a procedural flowchart for identifying resonant frequencies corresponding to plasma states, each characterized by a unique plasma impedance in the ALE process. The process 602 starts at step 608, where plasma impedances are computed using the chamber plasma digital twin 152. At step 610, resonant frequencies for the various plasma states are determined based on the RF digital twin 146. In step 612, the RF digital twin 146 is updated to reflect the newly determined resonant frequencies.

FIG. 6B sets forth a flowchart delineating the procedure for establishing the position of the movable part of the vacuum valve according to the gas digital twin 148. The process 604 begins at step 614, where the chamber pressure is calculated using the gas digital twin 148 based on an initial position of the movable part. Step 616 involves determining the optimized position of the movable part to achieve the desired chamber pressure. Finally, the gas digital twin 148 is updated in step 618 to integrate the optimized position or associated setpoint.

FIG. 6C illustrates a flowchart detailing the procedure for defining setpoints for a heater and a chiller. The process 606 starts with step 620, where the substrate surface temperature is computed by the temperature digital twin 150 using initial setpoints for the heater 128 and the chiller 130. In step 622, optimized setpoints are determined to maintain the substrate temperature within the desired range, utilizing the temperature digital twin 150. Step 624 updates the temperature digital twin 150 to include the optimized setpoints.

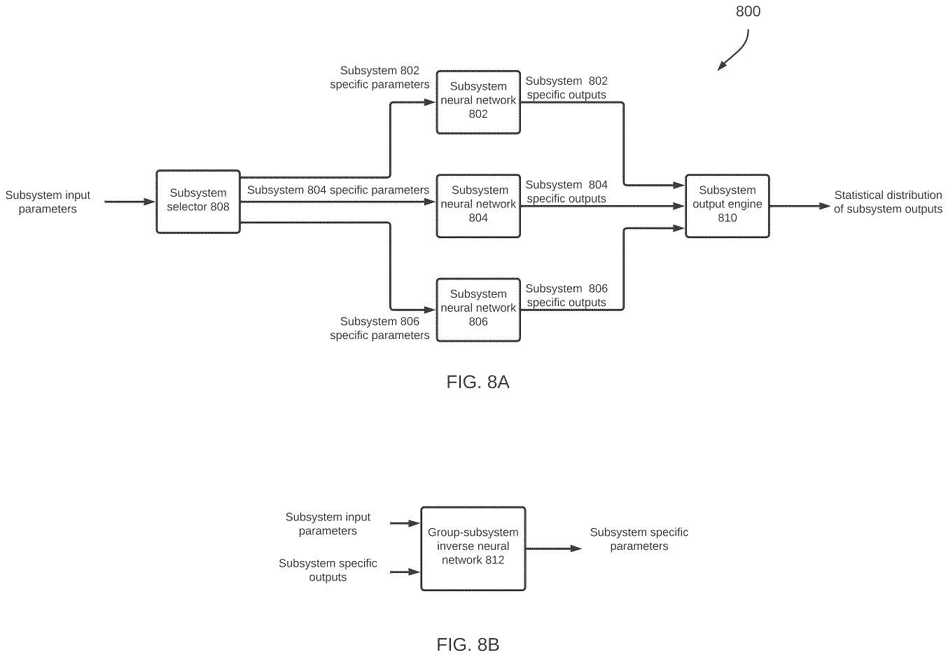

FIG. 8A showcases an embodiment of a group-subsystem digital twin, designated as 800. This digital twin 800 exemplarily includes subsystem neural networks 802, 804, and 806. In a typical group-subsystem digital twin, numerous subsystem neural networks are present. These neural networks are connected to the output of a subsystem selector 808. The subsystem selector 808 is configured to receive subsystem input parameters and select one neural network from the available ones for each simulation. This selection process is facilitated by a random number generator controlled by the group controller 162. In a specific implementation, each neural network is assigned an equal probability of selection. Once selected by the subsystem selector 808, the chosen subsystem neural network processes the subsystem-specific parameters along with the subsystem input parameters to generate the subsystem-specific outputs.

To illustrate the inventive concept, consider an RF subsystem as an example. For an exemplary RF subsystem, the subsystem-specific parameters might include values of the components for RF circuits, which can vary across different RF subsystems. Additional RF subsystem-specific parameters might include coil parameters for the plasma source. These parameters could be determined during the manufacturing process of the subsystem or during its post-integration into a chamber. The RF subsystem's outputs may encompass current, voltage, and phase delivered to a chamber's plasma source, as generated by a SPICE model based simulation or measured by respective sensors. The outputs may also include resonant frequency. Additionally, reflected power at a specific operating frequency, detected by directional couplers placed at the output of the RF power generator, might be among the outputs.

Multiple simulations can be executed, and their outputs are processed by the subsystem output engine 810. When a large number of simulations is conducted, the digital twin generates a statistical distribution of the subsystem outputs. The generated statistical distributions can be stored in a database.

FIG. 8B depicts a group-subsystem inverse neural network, designated as 812. This inverse neural network utilizes subsystem input parameters and subsystem-specific outputs as its inputs and subsystem-specific parameters as its outputs. It is trained by retrieving the data from the database, which constitutes the statistical distribution. Once the training is completed, the inverse neural network 812 can infer new subsystem-specific parameters by using the measured data of the subsystem outputs.

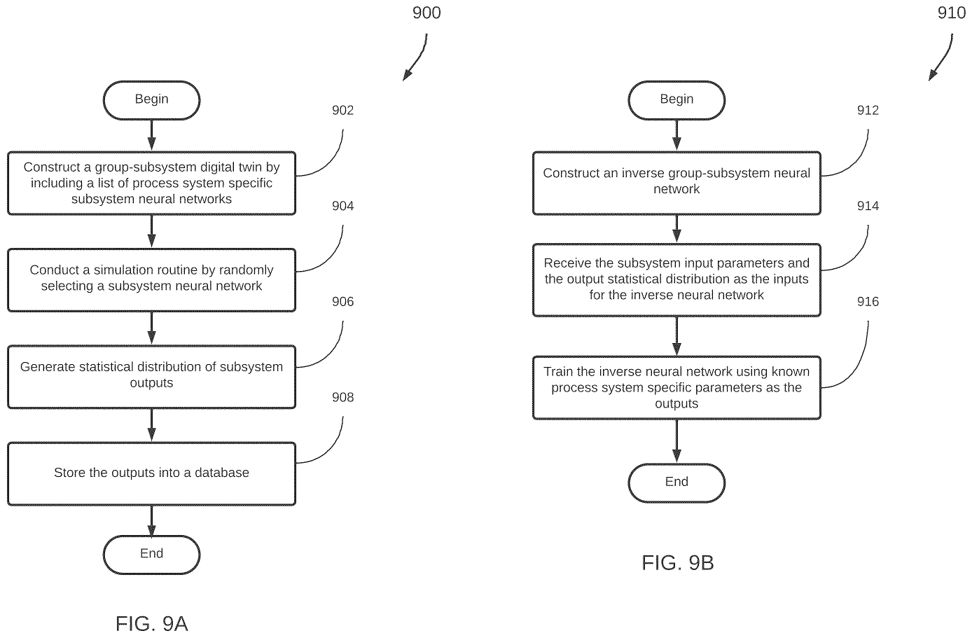

FIG. 9A illustrates a flowchart for process 900, designed to record simulated statistical distributions of subsystem outputs in a database. Process 900 begins with step 902, where a group-subsystem digital twin 800 is constructed for a selected type of subsystem, incorporating a list of subsystem-specific neural networks. In step 904, a simulation routine is executed, often repeatedly for predetermined number of times, to produce statistically significant subsystem outputs. Each simulation involves selecting one subsystem neural network using the random number generator. In one implementation, each subsystem in the list shares the same probability to be selected and the predetermined number of selections covers all the subsystem at least once. Step 906 generates statistical distributions of the outputs of the selected type of the subsystem. In step 908, these outputs, along with the subsystem input parameters and subsystem-specific parameters, are stored in a database with an appropriate data structure for future use.

FIG. 9B presents a flowchart for process 910, which details the construction of an inverse group-subsystem neural network 812. Process 910 begins with step 912, where the inverse neural network 812 is established by assigning initial weights. In step 914, the data stored in the database is retrieved to provide subsystem inputs parameters, the statistical distribution of the outputs, and associated subsystem-specific parameters. The inverse neural network is trained by the retrieved data in step 916. After the completion of the training, the inverse neural network 812 can infer the subsystem-specific parameters for a new subsystem using the subsystem inputs and the measured subsystem outputs.

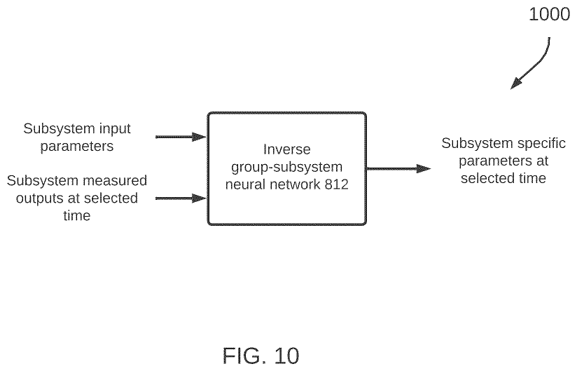

FIG. 10 depicts a schematic of an inverse subsystem neural network 812 applied to a new process system. The trained inverse neural network 812, operating in inference mode, accepts subsystem input parameters and newly measured subsystem outputs at a predetermined time as inputs, generating new subsystem-specific parameters as outputs. The predetermined time could be a moment when a new process system is introduced, or a process system after a preventive-maintenance procedure, or after an abnormality is detected from a sensor. The predetermined time could also be a moment according to a regular monitoring interval.

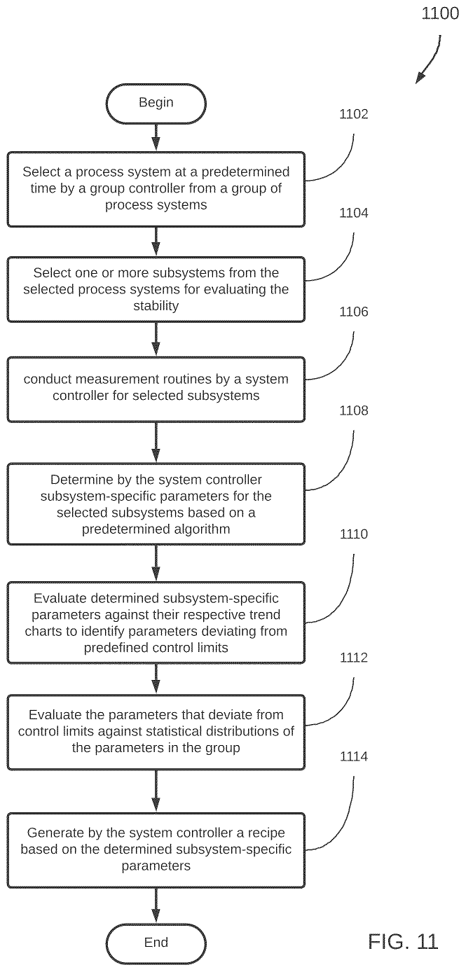

FIG. 11 presents a flowchart illustrating process 1100, designed for evaluating stability of a process system at a predetermined time. The objectives for process 1100 are to monitor subsystem-specific parameters at the time and to determine if variations of the parameters will affect the outcome of processing. Process 1100 starts with step 1102 that a process system is selected by the group controller 162 at the predetermined time as mentioned above. In step 1104, one or more subsystems is selected from the selected process system for evaluation. In step 1106, measurement routines are conducted by the measurement engine 142, supervised by the system controller 132 for selected subsystems. In step 1108, the system controller 132 determines subsystem-specific parameters according to a predetermined algorithm. In one implementation, the predetermined algorithm involves the inverse neural networks for the subsystems. In step 1110, the determined subsystem-specific parameters are evaluated against their respective trend charts to identify parameters deviating from predefined control limits.

In the context of statistical process control (SPC), trend charts are graphical tools that plot process parameters over time to monitor stability and detect deviations. They include control limits, target values, and highlight trends or shifts, enabling identification of abnormalities or process drift for proactive corrections. For example, in semiconductor manufacturing, a trend chart for ESC temperature can reveal instability of the temperature control subsystem.

In step 1112, the group controller 162 evaluates the parameters that deviate from control limits against statistical distributions of the parameters in the group. In step 1114, the system controller 132 attempts to generate autonomously a recipe based on the determined subsystem-specific parameters. If the generated recipe can deliver the outputs meeting the specifications, the risks associated with the deviation are low. Otherwise, the process system will need to go through a thorough troubleshooting procedure or be stopped for a preventive maintenance procedure.

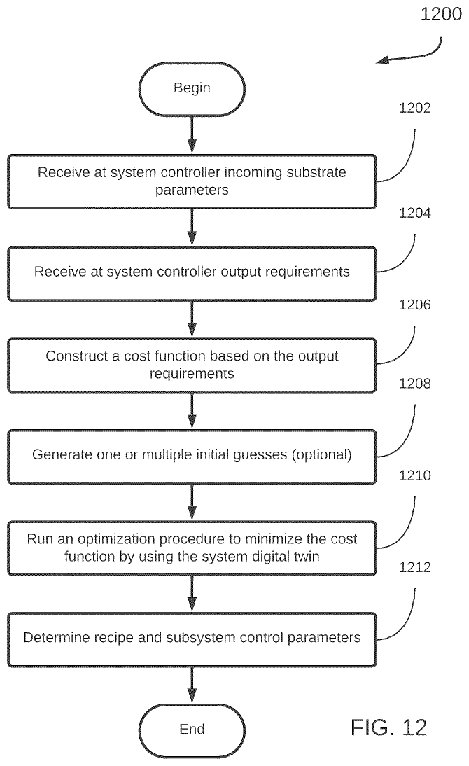

FIG. 12 presents a flowchart outlining a method for formulating process recipe parameters and subsystem control parameters utilizing the system digital twin 140. The process 1200 commences at step 1204 when the system controller 132 acquires incoming substrate parameters, as detailed in Table 1. In step 1206, the system controller 132 procures the output parameters for the structures to undergo etching, constructing a cost function based upon the output requirements in step 1208, typically formulated as a least squares cost function pertaining to each output parameter of the structure post the ALE processing. The cost function can be defined as:

$$c = {\sum }_{i = 1}^{N} {{w}_{i} ( {p}_{i} - {p}_{itarget} )}^{2} , \qquad [ 1 ]$$

where c is the cost, wᵢ is the weight, and pᵢ is a normalized output parameter like critical dimension at a selected vertical coordinate, p_{itarget} is the normalized target value of the output parameter, and N is serial number of the parameter. If multiple structures are evaluated, the cost function can be further expressed as:

$$C = {\sum }_{j = 1}^{M} {W}_{j} {c}_{j} , \qquad [ 2 ]$$

where C is the accumulated cost across multiple structures, Wⱼ is the weight, and cⱼ is the cost for one structure. The method can take several or many structures across a substrate like a 300 mm wafer. The method can further take different structures or different parts of the structure to quantify various loading effects. Therefore, the optimization process 1200 can be employed to optimize a single structure or multiple structures concurrently. In some implementations, if loading effects need to be modeled accurately, Equation [2] may include further additional terms which reflect correlations.

Proceeding to step 1210, initial guesses for the process recipe parameters and subsystem control parameters are devised, providing a basis to execute an optimization algorithm in step 1212. This optimization, aimed at minimizing the cost function, is performed in accordance with the ALE digital twin 156 or more efficiently the ALE neural network 400. The optimization can be carried out by many algorithms as known in the art, such as, for example, the stochastic gradient descent (SGD) method. At the conclusion of this process, at step 1214, the process recipe parameters and subsystem control parameters are established.

1. A method for monitoring stability of a process system, comprising:
selecting a process system at a predetermined time by a group controller from a group of process systems;
selecting one or more subsystems from the selected process system for evaluating the stability;
conducting a measurement routine by a system controller for selected subsystems;
determining, by the system controller, subsystem-specific parameters for the selected subsystems based on a predetermined algorithm;
evaluating determined subsystem-specific parameters against their respective trend charts to identify parameters deviating from predefined control limits;
evaluating the parameters that deviate from the control limits against statistical distributions of the parameters in the group; and/or
generating by the system controller a recipe based on the determined subsystem-specific parameters.

2. The method of claim 1, wherein the subsystems further include an RF subsystem, a gas distribution subsystem, a temperature control subsystem, a chamber surface subsystem, and a substrate edge subsystem.

3. The method of claim 2, wherein each subsystem is represented by a digital twin.

4. The method of claim 3, wherein the digital twin includes a neural network.

5. The method of claim 1, wherein each process system is represented by a process system-specific digital twin.

6. The method of claim 1, wherein the predetermined algorithm includes using inverse neural network for the subsystems, wherein the inverse neural networks utilize measured data generated from executing the measurement routines as inputs.

7. The method of claim 6, wherein the inverse neural networks are trained using a database generated through simulations utilizing digital twins for the subsystems.

8. The method of claim 1, wherein the predetermined time includes a moment when a new process system is introduced or when a process system has undergone a preventive maintenance procedure.

9. The method of claim 1, wherein the process system includes one of the following: an ALE process system, a reactive ion etching process system, a plasma-assisted chemical vapor deposition process system, a thermal deposition or etching process system, or an atomic layer deposition process system.

10. A group of process systems, comprising:
a group controller for managing operations of the process systems in the group;
a system controller for controlling a process system in the group, wherein the process system is represented by a process system-specific digital twin, which further includes subsystem-specific digital twins, a reactor digital twin, and a process digital twin that uses outputs from the reactor digital twin as inputs;
wherein the system controller determines subsystem-specific parameters at predetermined times by running measurement routines; and
wherein the group controller evaluates the subsystem specific parameters against statistical distributions of the parameters within the group and determines if the process system is operating outside of control limits based on a predetermined algorithm.

11. The group of the process systems of claim 10, wherein the system controller determines the subsystem-specific parameters using an inverse neural network.

12. The group of the process systems of claim 11, wherein the inverse neural networks use measured data from the measurement routines as inputs.

13. The group of the process systems of claim 11, wherein the inverse neural networks are trained using simulated data generated by digital twins.

14. The group of the process systems of claim 10, wherein the system controller determines the subsystem-specific parameters at predetermined times and establishes trend charts for these parameters.

15. The group of the process systems of claim 10, wherein the predetermined algorithm further includes generating a recipe through an optimization procedure for minimizing a cost function, wherein the cost function evaluates difference between the simulated and targeted outputs of structures on a substrate being etched.

16. The group of the process systems of claim 15, wherein the group controller decides the process system is outside of control limits if the generated recipe fails to meet the output specifications.

17. The group of the process systems of claim 10, wherein the subsystems further include an RF subsystem, a gas distribution subsystem, a temperature control subsystem, a chamber surface subsystem, and a substrate edge subsystem.

18. The method of claim 17, wherein each subsystem is represented by a digital twin.

19. The method of claim 18, wherein the digital twin includes a neural network.

20. The group of the process systems of claim 10, wherein the process system includes one of the following: an atomic layer etching process system, a reactive ion etching process system, a plasma-assisted chemical vapor deposition process system, a thermal deposition or etching process system, or an atomic layer deposition process system.
